(19) United States
(12) Patent Application Publication
(10) Pub. No.: US 2003/0038265 A1
(43) Pub. Date: Feb. 27, 2003

(54) Slide valve with wedging system

(76) Inventor: Andre F. Koerner, Missouri City, TX (US)

Correspondence Address: James F. Weiler, Attorney-at-Law, Suite 1560, One Riverway, Houston, TX, 77056, US

(21) Appl. No.: 09/767,548

(22) Filed: Jan. 23, 2001

(51) Int. Cl. F16K 25/00

(52) U.S. Cl. 251/203

(57) ABSTRACT

Disclosed is a slide valve suitable for very high temperature service, such as extremely high temperatures (2200° F. and higher), having a metal shell and a liner of refractory material, has ceramic internals and a wedging system including wedge means for wedging the slide valve against the orifice plate and seating around its orifice and wedge means for wedging the guides against the downstream side of the orifice plate thereby stabilizing the internals against movement due to thermal expansion and contraction. The slide valve is also desirable for use under lower temperatures as its wedge system firmly wedges the disc into stable sealing engagement with the orifice plate and closing the orifice under conditions of flow. Depending on the conditions of use, either one or a combination of the wedge means may be used.

### FIELD OF THE INVENTION

The present invention is directed to slide valves utilized for high temperature, high velocity, and abrasive flow as well as lower temperature and lower velocity flow.

### BACKGROUND OF THE INVENTION

Slide valves utilized for controlling high temperature and high velocity flow of abrasive product through the valve have the disadvantage in that the high temperatures cause expansion and contraction of the valve internals, such as the orifice plate with its orifice, slide guides and the disc that moves in the guides across the orifice plate and seats on the orifice plate for closing and opening the slide valve thus not effectively controlling flow therethrough. This is particularly true in flow through the slide valve at high temperatures such as 2200° F. and above in not maintaining these valve internals stable in position for effective opening, closing, and sealing the slide valve.

The present invention solves this long existing problem for maintaining the valve internals stable in position for effective opening, closing, and sealing of the flow way through the valve under extremes of temperatures and pressures. Also, the present invention solves the long existing need for maintaining the valve internals stable in position for effective opening, closing, and sealing the valve under lower and low temperatures and pressures of flow through the valve.

### PRIOR ART

The following patents represent the current state of the art with respect to slide valves.

Treichel et al., U.S. Pat. No, 5,301,712, discloses background information concerning slide valves, their applications, problems, and the like of slide valves in the field of use of the present invention to which reference is made. It also discloses a slide valve assembly including an orifice and a disc slidable in the guides of the orifice plate assembly. The orifice plate assembly is slidable into and out of position in the slide valve housing through a side opening via grooves formed in the inner walls of the housing.

Houston et al., U.S. Pat. No. 5,123,440, discloses a slide valve for use in high temperature environments. The mounting ring of the slide valve is propped against the bed plate by a plurality of columns which are adjustable by screws connecting gussets to rails upon which the slide or disc slides.

Wiese, U.S. Pat. No. 5,096,099, discloses a slide valve with an adjustable cover that is connected at an opening to a container by a plurality of socket head screws.

Owens et al., U.S. Pat. No. 5,082,247, discloses a split seat gate valve located within a length of pipeline. The valve is disposed between flanged openings in the pipeline and is secured by a plurality of bolts.

Purvis, U.S. Pat. No, 4,612,955, discloses an edge wear tab used to prevent corrosion around the orifice in high temperature applications. Discs are slidably mounted in rails which are bolted to the valve housing.

Graf et al., U.S. Pat. No. 4,542,453, discloses a slide valve for high temperature gas lines.

Jandrasi et al., U.S. Pat. No. 4,531,539, discloses a slide valve. The orifice plate of the slide valve is releasably secured in place by bolts running parallel to flow direction.

Jandrasi et al., U.S. Pat. No. 4,512,363 discloses a valve assembly wherein the valve internals (orifice assembly, valve seat, guides, and disc) are removably secured to the valve body by a clamping action.

Jandrasi et al., U.S. Pat. No. 4,458,879, discloses a valve wherein the valve internals are held in position by a clamping action of a quick make-up cylinder.

Worley et al., U.S. Pat. No. 4,253,487, discloses a slide valve using a pair of opposing discs to control fluid flow through the valve.

U.S. Pat. No. 4,152,363 discloses a slide valve with guides held in place by clamping action and has a refractory lining.

U.S. Pat. No. 4,458,879 discloses a slide valve with refractory lining in which the guides are maintained out of the flow path and held in place by clamping action.

U.S. Pat. No. 5,123,440 discloses a slide valve with a disc or gate covered by a layer of refractory insulating material.

U.S. Pat. No. 4,541,453 discloses a slide valve with refractory insulating material whereby the disc is held in tension.

U.S. Pat. No. 4,253,487 discloses a slide valve with a refractory lining.

U.S. Pat. No. 3,976,094 discloses a slide valve with a refractory layer.

U.S. Pat. No. 3,701,359 discloses a slide valve with refractory lining.

In valves of this type manufactured and sold by Tapco, a division of Triten Corporation of Houston, Tex., the outer metal body is lined with a refractory material. Ultimately, the valve body may be lined with insulating material, the latter lined with refractory material. This results in a so called “cold shell” design where external body temperatures are minimized.

Although these valves have experienced considerable success, for extremely high temperature (i.e. above approximately 1500° F.) problems have been encountered in stabilizing against thermal expansion and contraction the orifice plate and its orifice, the guides, and the disc sliding in the guides into and out of position for opening, closing, and sealing the orifice when seating and unseating on the orifice plate due to instability in position caused by such thermal expansion and contraction.

It would be advantageous to provide a slide valve in which the orifice plate, its orifice, the slide guides, and the disc are maintained in a stable position under extreme conditions of temperatures which otherwise would cause movement due to thermal expansion and contraction as well as providing them stabilized in operation for low temperature and pressures for effective closing of the slide valve.

### SUMMARY OF THE INVENTION

The present invention is directed to such a slide valve in which product flow is controlled through the valve. Advantageously, the slide valve includes a wedging system in which the valve internals comprising the orifice plate with its orifice, disc guides, and disc which moves in the guides across the orifice plate and seats on the orifice plate, are wedged and hence maintained in stable position throughout the opening, closing, and sealing of the slide valve for controlling flow therethrough. The slide valve is particularly suited for flow through the slide valve at high temperatures such as 2200° F. and above thereby providing stable and hence effective opening, closing and sealing of the flow passage. The wedging system includes wedge means which are operable to wedge the disc against the orifice plate upon the movement of the disc from an open position to a closed position and to release the wedge of the disc to the orifice plate upon the movement of the slide valve to the open position.

The wedging system also includes wedge means having coacting engagable wedge surfaces on the disc's outer end and an engagable coacting wedge in the body operable to wedge the disc to the orifice plate, and wedge means engaging downstream surfaces of the guides operable to wedge the guides against the orifice plate. Either both or one of the wedge means can be used effectively to accommodate the conditions of use.

Preferably, the slide valve is lined with a refractory material which contains the flow way through the valve, and for extremely high temperature use ceramic internal parts, such as for the orifice plate, the disc, guides, and the wedge means. For lower temperatures the liner of refractory material may be omitted and the internal parts may be made of nonceramic materials, such as steel and the like. Further details and aspects of the improved slide valve with the wedging system and means of the present invention are set forth in the following description of preferred embodiments.

Accordingly, it is an object of the present invention to provide such a slide valve in which the internal parts assembly is maintained stably in place in the valve under all conditions of use including extremely high temperatures and pressures as well as lower temperatures and pressures.

It is a further object of the present invention to provide such a slide valve which is much stronger than slide valves in maintaining the internal parts in place in the valve by using the wedging system of the present invention.

It is yet a further object of the present invention to provide such a slide valve which provides improved sealing on closure by means of wedging the disc against the downstream side of the orifice plate.

It is yet a further object of the present invention to provide such a slide valve which may be utilized effectively for controlling flow through it for all sizes and under all conditions of use from low temperatures to extremely high temperature pressures, abrasive flows.

Other and further objects, features, and advantages are set forth and are inherent in the slide valve as set forth throughout the specification and claims.

### BRIEF DESCRIPTION OF THE DRAWINGS

FIG. 1 is an elevational view in section of a slide valve of the present invention.

FIG. 2 is a sectional view of the slide valve of FIG. 1 taken along the line 2-2.

FIG. 3 is a sectional view of the slide valve of FIG. 1 taken along the line 3-3.

### DESCRIPTION OF THE PREFERRED EMBODIMENTS

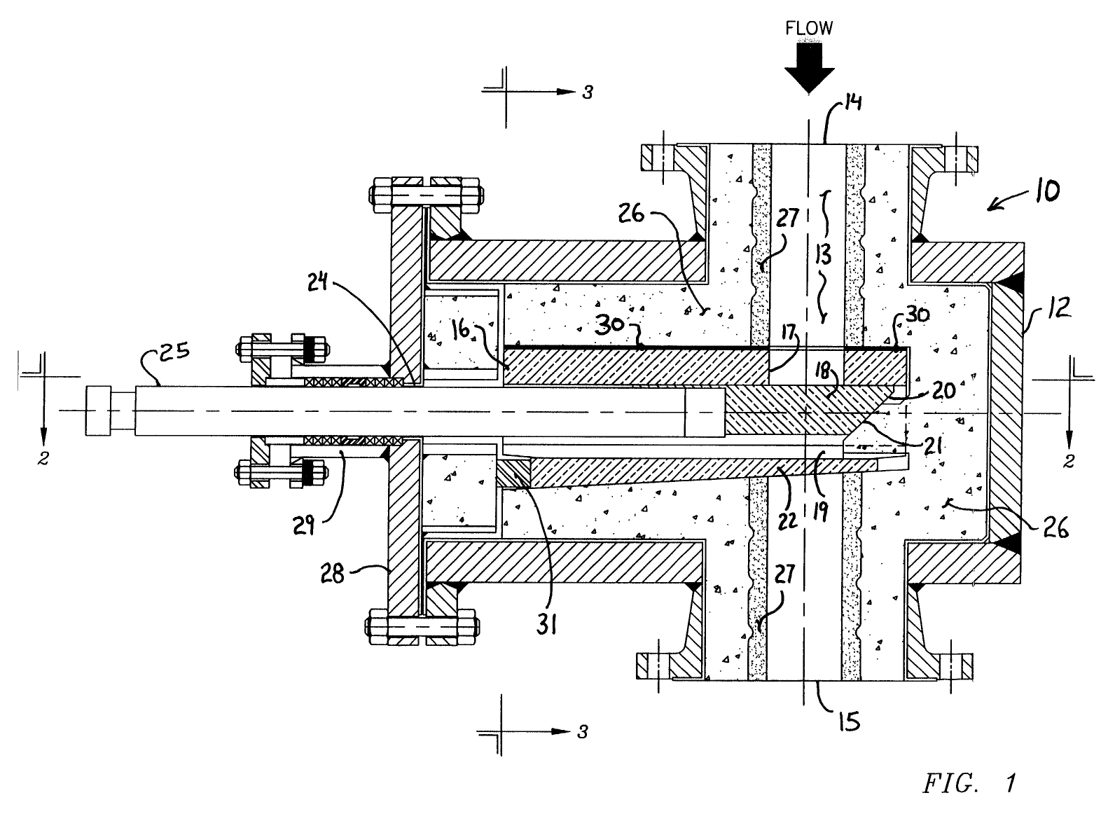

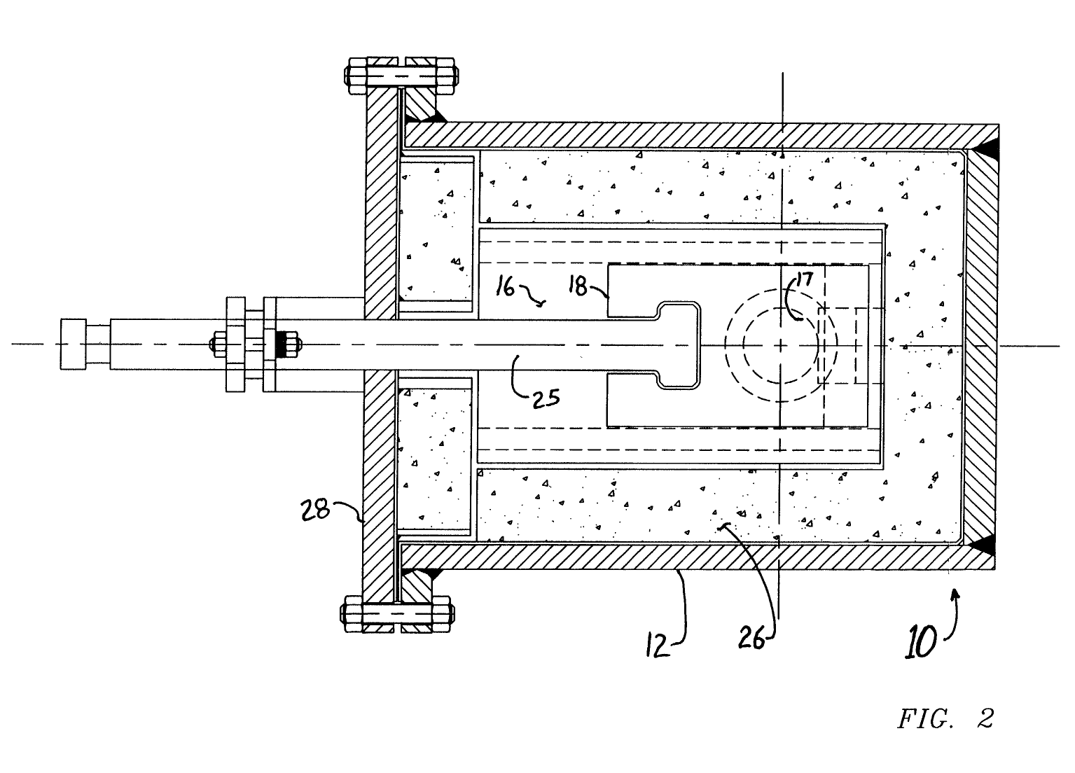

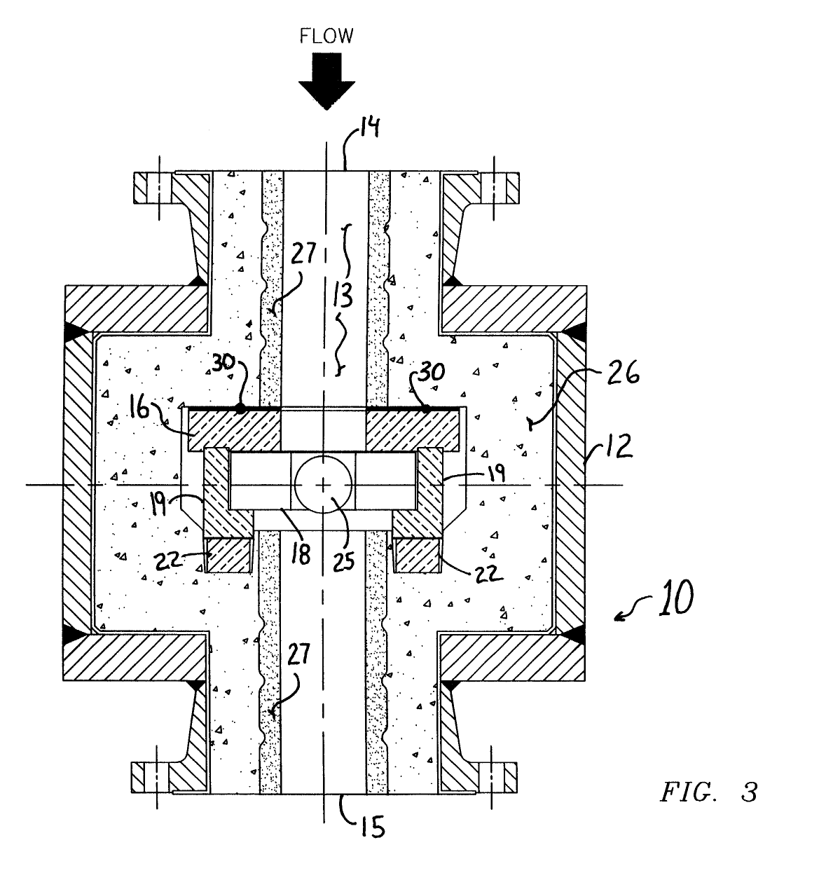

Referring to FIGS. 1, 2, and 3, an improved slide valve 10 of the present invention is illustrated which includes the valve body 12 having the flow way 13, and an inlet 14 at the upstream end and an outlet 15 at the downstream end. An internal slide valve assembly having an orifice plate 16 with the orifice 17 disposed in and forming a portion of the flow way 13, a disc 18, guides 19 in which the disc 18 slides (see FIG. 3), movement of the disc 18 to open the orifice 17 and to sealingly close the orifice 17 on movement of the disc 18 to a closed position.

The wedging system includes wedge means operable to wedge the disc 18 to the orifice plate 16 when the disc 18 is in closed position and to release the wedge of the disc 18 to the orifice plate upon movement of the disc 18 from the closed position to the open position. In this connection, there are two wedge means in the wedging system which advantageously can be used separately or coactively depending on the conditions of use of the temperatures and pressures of flow streams through the flow way 13. One of the wedge means comprises coacting engagable wedge surfaces 20 on the disc's 18 outer end and 21 in the body 12 operable to wedge the disc 18 to the downstream surface of the orifice plate 16 upon movement of the disc 18 to and when in the closed position as shown in FIGS. 1, 2, and 3.

Another coacting wedge means of the wedging system provides engaging surfaces of the wedge 22 and the guides 19 operable to wedge the guides 19 against the orifice plate 16.

As previously mentioned, depending upon the conditions of use, only one of the wedging means can be utilized, but when necessary or desired such as temperatures ranging 1500° F. and higher, it is advantageous to use both wedging coacting means to stabilize the internals in position to minimize leakage through the valve when closed.

The valve body 12 has the opening 24 intersecting the flow way 13 intermediate the inlet 14 and outlet 15 and is provided with the stem 25 extending sealably through the opening 24 by virtue of the packing assembly or stuffing box 29 to move the disc 18 from open to closed position. No detailed description is given or deemed necessary of the packing assembly or stuffing box 29 as they are in widespread use, and any suitable sealing means which prevent leakage and permit movement of the stem 25 can be used. Preferably the disc 18 is connected to the stem 25 by a T connection; however, any desired connection of the stem 25 to the disc 18 may be utilized. The side opening 24 of the body 12 is closed by a closure body member or cover flange 28 as indicated in the drawings so that the internal parts of the slide valve may be removed and repaired or replaced.

For extreme temperatures, a lining of ceramic material 27 is used to form the flow way 13, and a flexible and compressible sheet 30, such as a ceramic fiber paper or flexible graphite sheet is provided between the orifice plate 16 and the body refractory lining 26 which serves as a high temperature and high pressure gasket providing a tight seal as described in more detail subsequently herein.

As best seen in FIG. 1, the stop blocks 31 are provided to maintain the wedges 22 and thereby the orifice plate 16, its orifice 17, and the guides 23 in stable position during opening and closing of the slide valve 10.

Any refractory material having sufficient strength can be used for the refractory lining 26 and is available from a number of suppliers, including Harbison Walker (Pittsburgh, Pa.), National Refractories (Oakland, Calif.), Norton Co. (Worchester, Mass.), The Carborundum Co. (Niagara Falls, N.Y.), Resco Products, Inc. (Norristown, Pa.), Plibrico (Chicago, Ill.), and A. P. Green (Mexico, Mo.). Any such refractory material having a modulus of rupture (MOR) over about 1200 psi at normal operating temperatures (about 1400 to about 1900 psi is preferred) is suitable for lower temperature use in the present invention; and many commercially available composites can either be modified by adding alumunina and/or zirconia to increase MOR or by varying such parameters as aggregate size, cooling rate, pressure, percentable solids, vibration frequency, all as are known in the art, to maximize the strength thereof for use in accordance with the present invention in the desired service application.

For extremely high temperatures, pressures, and abrasive flows, preferably the valve body is of carbon steel pressure retaining vessel ASTM A516 grade 70. Other carbon steels rated for pressure can be utilized. For corrosion purpose, a stainless steel could be utilized.

Preferably, the body lining of refractory material 26 is about 3 to 5 inches in thickness. For extreme service the refractory material should be castable and generally containing about 60 percent alumina. Such a refractory lining material is available on the open market under the trade name Resco RS-17EC.

Another refractory lining material is Harbison Walker's Novacon-65. It can be used for high design temperature of 2200° F. and above, is suitably rigid and provides mounting surfaces for ceramic internal parts, and is erosion resistant to product flow.

Preferably, the internal parts for extremely high temperature use are ceramic, a special type of refractory material, which include the orifice plate 16, the disc 18, the guides 19, the wedges 22, and refractory material for the inlet and outlet liners 27. An aluminum-zirconia-silica fused cast ceramic under the trade name Corguard-AZS is available from Cohart Refractories (Louisville, Ky.). It is selected for high temperature strength, has low erosion properties, and can be ground to exacting tolerances.

Preferably the valve stem or shaft 25 is generally an oversized stem of silicon carbide, such as Cryston silicon carbide. It has high tensile strength at elevated temperature in excess of 2000° F. and excellent thermal shock characteristics (high to low temperature). Good thermal shock properties are necessary for the valve stem or shaft 25 since it is exposed to both high temperature inside the valve and much lower (ambient) temperature outside the valve. Other materials, however, which can stand the conditions of use can be utilized for the valve stem or shaft 25.

Preferably the ceramic fiber paper or flexible graphite sheet 30 is about a 1/16th inch thickness layer, that is provided between the orifice plate 16 and the body refractory material 26. It is a compressible and flexible high temperature and high pressure gasket. It provides a tight seal between the internal ceramic orifice plate 16 and the slide valve body lining 26, has compressibility for a tight and secure fit and also is a flexible barrier to vibration and body distortion that may otherwise crack the ceramic internals. Other materials having compressibility and flexibility can be substituted which withstand the conditions of use.

Accordingly, the present invention is well suited and adapted to attain the objects and ends and has the advantages and features mentioned as well as others inherent therein.

While presently preferred embodiments have been given for the purpose of disclosure, changes can be made therein which are within the spirit of the invention as defined by the scope of the appended claims.

What is claimed is:

1. An improved slide valve comprising,
a body having a valve chamber with a flow way therethrough having an upstream entrance and a downstream outlet,
an internal slide valve assembly having an orifice plate with an orifice, a disc and guides disposed adjacent to and downstream of the orifice plate secured in the body, the disc operable to open the orifice on movement of the disc to open position and to sealingly close the orifice on movement of the disc to closed position, and
a wedging system operable to wedge the slide valve against the orifice plate when in the closed position and to release the wedge of the disc to the orifice plate upon the movement of the slide valve from the closed position to the open position.

2. The improved slide valve of claim 1 where the wedging system comprises,
wedge means having coacting engagable wedge surfaces on the disc's outer end and a wedge in the body operable to wedge the disc to the orifice plate when in the closed position.

3. The improved slide valve of claim 1 where the wedging system comprises,
wedge means engaging downstream surfaces of the guides operable to wedge the guides against the orifice plate when in the closed position.

4. The improved slide valve of claim 1 where the wedging system comprises,
wedge means coacting engagable wedge surfaces on the disc's outer end and a wedge in the body operable to wedge the disc to the orifice plate upon engagement of the wedge surfaces in the closed position, and
wedge means engaging downstream surfaces of the guides operable to wedge the guides against the orifice plate when in the closed position.

5. The improved slide valve of claim 1 including,
an opening in the body intersecting the flow way intermediate the inlet and the outlet, and
a stem extending sealably through the opening and connected to the disc operable to move the disc to the open position and to the closed position.

6. The improved slide valve of claim 2 including,
an opening in the body intersecting the flow way intermediate the inlet and the outlet, and
a stem extending sealably through the opening and connected to the disc operable to move the disc to the open position and to the closed position.

7. The improved slide valve of claim 3 including,
an opening in the body intersecting the flow way intermediate the inlet and the outlet, and
a stem extending sealably through the opening and connected to the disc operable to move the disc to the open position and to the closed position.

8. The improved slide valve of claim 1 including,
a lining of refractory material in the body forming the flow way, the upstream entrance, and the downstream entrance.

9. The improved slide valve of claim 2 including,
a lining of refractory material in the body forming the flow way, the upstream entrance, and the downstream entrance.

10. The improved slide valve of claim 3 including,
a lining of refractory material in the body forming the flow way, the upstream entrance, and the downstream entrance.

11. The improved slide valve of claim 1 including,
a lining of refractory material in the body forming the flow way, the upstream entrance, and the downstream entrance, and where
the orifice plate, disc, guides, and wedging system are made of a refractory material capable of withstanding conditions of temperature and erosive flow through the flow way.

12. The improved slide valve of claim 2 including,
a lining of refractory material in the body and forming the flow way, the upstream entrance, and the downstream entrance, and where
the orifice plate, disc, guides, and wedge are made of a refractory material capable of withstanding temperature conditions of flow through the flow way.

13. The improved slide valve of claim 3 including,
a lining of refractory material in the body forming the flow way, the upstream entrance, and the downstream entrance, and where
the orifice plate, disc, guides, and wedge are made of a refractory material capable of withstanding temperature conditions of flow through the flow way, and
the wedge means.

14. The improved slide valve of claim 3 including,
a lining of refractory material in the body forming the flow way, the upstream entrance, and the downstream entrance, and where
the orifice plate, disc, guides, and their downstream surfaces, and the wedge means are made of a refractory material capable of withstanding flow through the flow way.

15. The improved slide valve of claim 1 including,
an opening in the body intersecting the flow way intermediate the inlet and the outlet,
a stem extending sealably through the opening and connected to the disc operable to move the disc to the open position and to the closed position,
a lining of refractory material in the body forming the flow way, the upstream entrance, and the downstream entrance, and where
the orifice plate, disc, guides and wedge means are made of a refractory material capable of withstanding temperature conditions of flow through the flow way, and
a stem extending sealably through the opening and connected to the disc operable to move the disc to the open position and the closed position,
the stem made of a material that withstands thermal shock.

16. The improved slide valve of claim 1 where,
the lining of refractory material is a ceramic material, and
the refractory material is disposed between the ceramic material and inside the body.
